(19) United States
(12) Patent Application Publication
(10) Pub. No.: US 2018/0276349 A1
(43) Pub. Date: Sep. 27, 2018

(54) DIGITAL CONTENT EDITING APPARATUS, DIGITAL CONTENT PLAYBACK APPARATUS, DIGITAL CONTENT DECRYPTING APPARATUS, WEB CONTENT PLAYBACK APPARATUS, WEB CONTENT DECRYPTING APPARATUS, DIGITAL CONTENT ENCRYPTING/DECRYPTING SYSTEM, AND DIGITAL CONTENT ENCRYPTING/DECRYPTING METHOD

(71) Applicant: Mitsubishi Electric Corporation, Tokyo (JP)

(72) Inventors: Shingo MINE, Tokyo (JP); Momoyo NAGASE, Tokyo (JP); Tetsuro SEKI, Tokyo (JP); Takashi NAKAMURA, Tokyo (JP); Shinichi JOHYAMA, Tokyo (JP)

(73) Assignee: Mitsubishi Electric Corporation, Tokyo (JP)

(21) Appl. No.: 15/556,262

(22) PCT Filed: Apr. 19, 2016
(86) PCT No.: PCT/JP2016/062323

§ 371 Date: Sep. 6, 2017

(30) Foreign Application Priority Data
May 18, 2015 (JP) 2015-101146

(51) Int. Cl. G06F 21/10; G06F 21/60

(52) U.S. Cl. CPC G06F 21/10; G06F 2221/0724; G06F 21/602

(57) ABSTRACT

A digital content editing apparatus includes: a digital content generating unit for processing data and generating digital content constituted by a group of files, the digital content; and an encrypting unit for encrypting encryption target files among the group of files constituting the digital content generated by the digital content generating unit by using a part of the group of non-encryption target files among the group of files constituting the digital content.

### TECHNICAL FIELD

The invention relates to a digital content editing apparatus, a digital content playback apparatus, a digital content decrypting apparatus, a digital content encrypting/decrypting system, and a digital content encrypting/decrypting method that are used to securely distribute digital content including video, audio, text, etc.

### BACKGROUND ART

Conventional methods of providing viewers with digital content including video, audio, text, etc., such as a web learning material used for in-company training, include: a method of distributing digital content over a network from a distribution apparatus, such as a web server, and a method of distributing digital content by storing it in a recording medium, such as a CD or DVD.

When digital content including high volume video is distributed over a network from a small-scale office or overseas office at which video distribution network environment, such as a wideband line and a streaming server, is not sufficiently set up, it takes time to distribute the digital content and thus it is difficult to view the digital content. In addition, even in an environment in which a somewhat wideband line is set up, there is a concern that when high volume video is distributed, data communication performed on the delivery may deteriorate other communication of a business system.

On the other hand, as for the method of distributing digital content by storing it in a recording medium, this method can be used even in an environment where a network environment is not set up; however, operation and management that utilize a network, such as user authentication in cooperation with a server and management of a digital content viewing log, are infeasible.

As a solution to the above-described problems, a method is conceivable which distributes video, which is high volume in digital content, with a recording medium, distributes files other than the video, such as HTML and a script, over a network from a distribution apparatus, and integrates the video and the files at a display apparatus to playback.

In addition, conventionally, when highly confidential information is distributed on a recording medium, in order to ensure secrecy in case of loss or theft, data that requires encryption is encrypted. Examples of encryption methods include: file encryption for encrypting files, archive encryption for encrypting archived files, virtual disk encryption that carries out encryption by storing files in a virtual disk file that can be mounted on a PC. In these encryption methods, normally, encryption is performed by setting a password, but a key file which serves as an encryption/decryption key can also be used together with the password. When a key file is used, since encryption and decryption are performed by combination of pieces of password and key file information, security can be strongly ensured compared with the case in which only a password is used.

As a single information playback apparatus that uses both the content to be delivered over a network and the content from a recording medium which are related to each other, for example, Patent Literature 1 discloses a content providing system in which an information playback apparatus obtains identification information of a terminal apparatus connected by wire or wireless to the information playback apparatus and content identification information of a recording medium, identifies a content providing apparatus connected thereto through a network, and transmits the two pieces of identification information to request the identified content providing apparatus to deliver content related to content of the recording medium.

In addition, Patent Literature 1 discloses that an encryption key and an encryption algorithm are recorded in a recording medium, the information playback apparatus encrypts terminal apparatus identification information and content identification information using the encryption key and the encryption algorithm, and the content providing apparatus decrypts the encrypted terminal apparatus identification information and content identification information using a decryption key and a decryption algorithm, and delivers content.

### CITATION LIST

### Patent Literature

Patent Literature 1: JP 2012-14759 A

### SUMMARY OF INVENTION

### Technical Problem

In the conventional art as described in Patent Literature 1, however, there is a problem that a content creator bears the burden of creating and distributing a key file including an encryption key separately from content, and managing the key file separately from a decryption key.

The invention has been made to solve the problems described above, and an object of the invention is to provide a digital content editing apparatus, a digital content playback apparatus, a digital content decrypting apparatus, a digital content encrypting/decrypting system, and a digital content encrypting/decrypting method that allow to perform encryption and decryption using a key file by creating and delivering, by a creator, digital content without separately creating a key file, by which the burden of management and operation for when digital content is encrypted and distributed can be reduced.

### Solution to Problem

A digital content editing apparatus according to the invention includes: a digital content generating unit for processing data and generating digital content constituted by a group of files; and an encrypting unit for encrypting a group of encryption target files among the group of files constituting the digital content, using a part of a group of non-encryption target files among the group of files constituting the digital content generated by the digital content generating unit.

### Advantageous Effects of Invention

According to a digital content editing apparatus, a digital content playback apparatus, and a digital content encrypting/decrypting system of the invention, it is configured such that encryption is performed using some of digital content files as a key file(s), and upon decryption, the key file(s) is automatically obtained. Thus, encryption and decryption using a key file can be performed by creating and delivering, by a creator, digital content without separately creating a key file, and accordingly, the burden of management and operation for when digital content is encrypted and distributed can be reduced.

### BRIEF DESCRIPTION OF DRAWINGS

FIG. 1 is a diagram describing a configuration of a digital content encrypting/decrypting system according to Embodiment 1 of the invention.

FIG. 2 is a configuration diagram of an authoring apparatus having mounted thereon a digital content editing apparatus according to Embodiment 1 of the invention.

FIG. 3 is a configuration diagram of a display apparatus according to Embodiment 1 of the invention.

FIG. 4 is a diagram describing a hardware configuration of the authoring apparatus in Embodiment 1.

FIG. 5 is a diagram describing a hardware configuration of the display apparatus in Embodiment 1.

FIG. 6 is a flowchart describing the operation of the authoring apparatus having mounted thereon the digital content editing apparatus according to Embodiment 1 of the invention.

FIG. 7 is a flowchart describing the operation of the display apparatus according to Embodiment 1 of the invention.

FIG. 8 is diagram describing a configuration of a digital content encrypting/decrypting system according to Embodiment 2 of the invention.

FIG. 9 is a configuration diagram of a display apparatus according to Embodiment 2 of the invention.

FIG. 10 is a flowchart describing the operation of an authoring apparatus having mounted thereon a digital content editing apparatus according to Embodiment 2 of the invention.

FIG. 11 is a flowchart describing the operation of the display apparatus according to Embodiment 2 of the invention.

FIG. 12 is a configuration diagram describing a configuration in which the display apparatus of Embodiment 2 of the invention includes an invisibility control unit.

FIG. 13 is a configuration diagram of a display apparatus according to Embodiment 3 of the invention.

FIG. 14 is a flowchart describing the operation of the display apparatus according to Embodiment 3 of the invention.

### DESCRIPTION OF EMBODIMENTS

Embodiments of the invention will be described in detail below with reference to the drawings.

### Embodiment 1

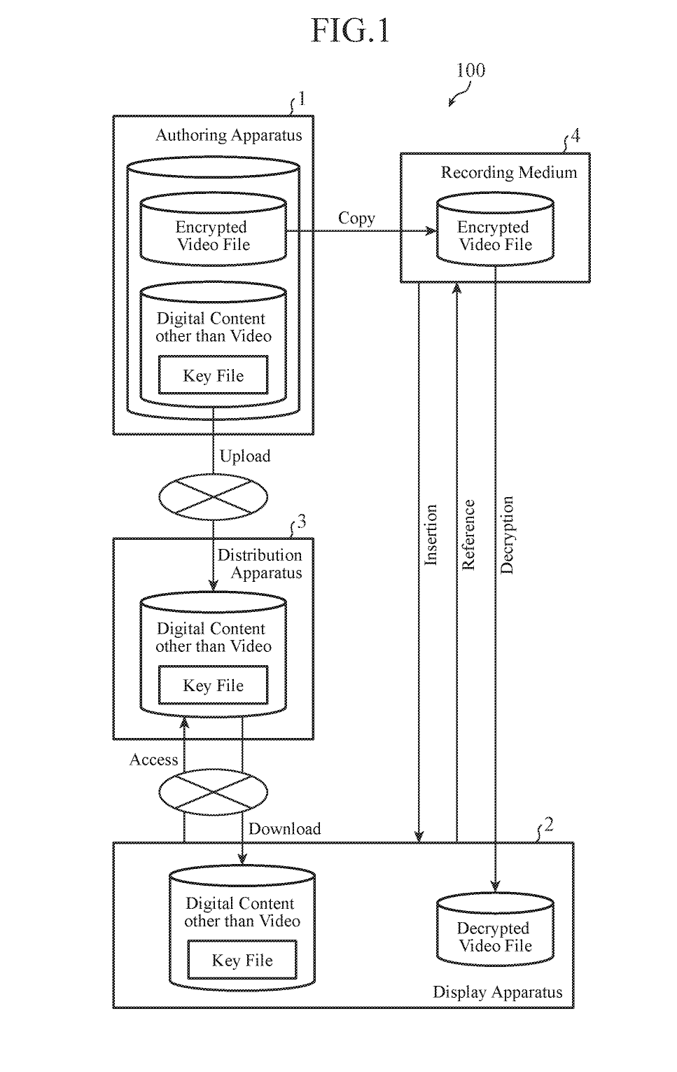

FIG. 1 is a diagram describing a configuration of a digital content encrypting/decrypting system 100 according to Embodiment 1 of the invention.

As shown in FIG. 1, the digital content encrypting/decrypting system 100 includes an authoring apparatus 1, a display apparatus 2, a distribution apparatus 3, and a recording medium 4.

Note that here, for convenience of description, content data to be exchanged in the digital content encrypting/decrypting system 100 is also shown in FIG. 1.

The authoring apparatus 1 is, for example, a PC. The authoring apparatus 1 generates digital content constituted by a group of files, and uploads the digital content (first digital content) among the group of files that constitute the generated digital content except for video to the distribution apparatus 3. In addition, a video file (second digital content) among the group of files that constitute the generated digital content is copied to the recording medium. Note that the authoring apparatus 1 encrypts the video file and copies the encrypted video file to the recording medium 4.

The distribution apparatus 3 is, for example, a web server. The distribution apparatus 3 makes digital content files, etc., open to a network to distribute the digital content files, etc. In the digital content encrypting/decrypting system 100 according to Embodiment 1, the distribution apparatus 3 receives the digital content other than video that is uploaded from the authoring apparatus 1, and delivers the digital content other than video in response to access from the display apparatus 2.

The recording medium 4 is a portable optical disc that can record data, such as a CD or DVD, and records the encrypted video file that is copied from the authoring apparatus 1.

The display apparatus 2 is, for example, a PC. The display apparatus 2 accesses the distribution apparatus 3 to download the group of files of digital content except for the video, and also refers to the video file on the recording medium 4 to encrypt the encrypted video file, thereby playing back the digital content.

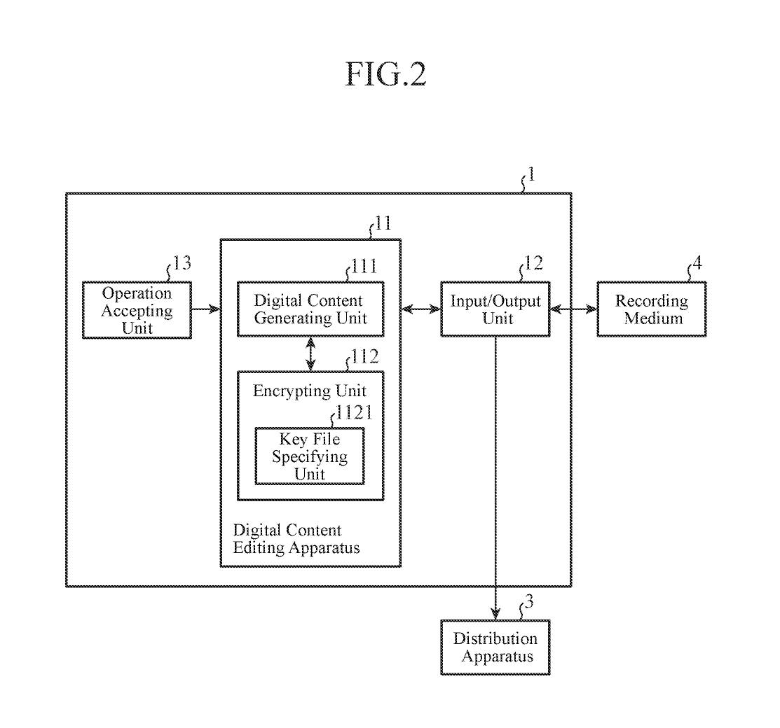

FIG. 2 is a configuration diagram of the authoring apparatus 1 having mounted thereon a digital content editing apparatus 11 according to Embodiment 1 of the invention.

The authoring apparatus 1 includes the digital content editing apparatus 11, an input/output unit 12, and an operation accepting unit 13.

The operation accepting unit 13 accepts GUI operations performed by a creator using, for example, a mouse.

The digital content editing apparatus 11 is that which creates, for example, digital content such as web learning materials, which includes video, audio, text, and so on, and includes a digital content generating unit 111 and an encrypting unit 112.

The digital content generating unit 111 obtains data such as video, audio, and text accepted by the input/output unit 12, and processes the data based on the creator's instructions accepted by the operation accepting unit 13, thereby generating digital content based on the processed data.

The encrypting unit 112 encrypts part of the group of files of the digital content generated by the digital content generating unit 111.

Specifically, the encrypting unit 112 includes a key file specifying unit 1121. When the key file specifying unit 1121 specifies a file that is used as a key file from among the group of files that constitute the digital content, the encrypting unit 112 encrypts the digital content using the key file specified by the key file specifying unit 1121. Note that there may be a single or a plurality of key files.

Note that the digital content encrypted by the encrypting unit 112 includes an encrypted video file which is encrypted using the key file specified by the key file specifying unit 1121, and a group of files other than the video, i.e., digital content other than video. In encryption, part of the group of files of the digital content except the video is used as a key file(s) (see FIG. 1).

The input/output unit 12 uploads the digital content other than video among the group of files that constitute the digital content, to the distribution apparatus 3. In addition, the input/output unit 12 copies the encrypted video file among the group of files that constitute the digital content, to the recording medium 4.

In addition, the input/output unit 12 accepts and loads data such as video, audio, and text from an external apparatus such as a video camera, and outputs the data to the digital content editing apparatus 11. The digital content editing apparatus 11 generates digital content from the data.

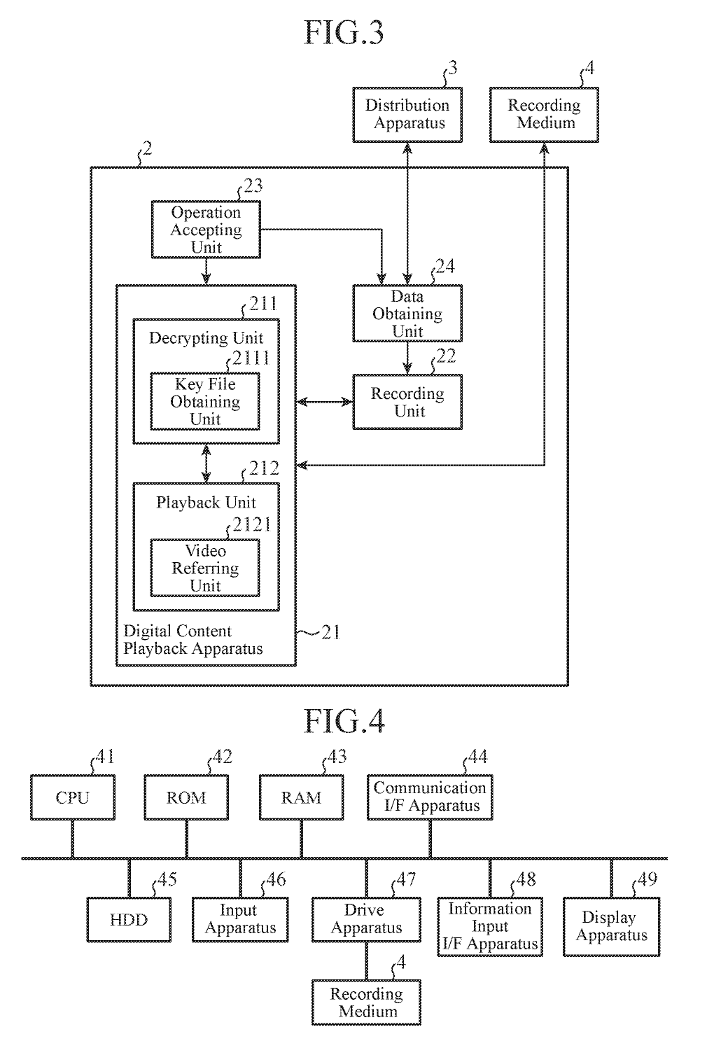

FIG. 3 is a configuration diagram of the display apparatus 2 according to Embodiment 1 of the invention.

The display apparatus 2 includes a digital content playback apparatus 21, a recording unit 22, an operation accepting unit 23, and a data obtaining unit 24.

The digital content playback apparatus 21 includes a decrypting unit 211 and a playback unit 212. The decrypting unit 211 and the playback unit 212 further include a key file obtaining unit 2111 and a video referring unit 2121, respectively.

The decrypting unit 211 of the digital content playback apparatus 21 refers to the encrypted video file stored in the recording medium 4 to decrypt digital content.

Specifically, the key file obtaining unit 2111 obtains a key file from the group of files of digital content except for the video which are downloaded from the distribution apparatus 3 and recorded in the recording unit 22, and the decrypting unit 211 decrypts, using the key file, the encrypted video file which is loaded from the recording medium 4.

The playback unit 212 of the digital content playback apparatus 21 plays back digital content.

Specifically, the playback unit 212 integrates the decrypted video file which is referred to by the video referring unit 2121 and the group of files of digital content except for the video, thereby playing back digital content.

The data obtaining unit 24 accesses the digital content except for the video on the distribution apparatus 3 to download the group of files of digital content except for the video. In addition, the downloaded group of files of the digital content except for the video is temporarily saved in the recording unit 22.

The recording unit 22 temporarily saves the group of files of the digital content other than video which is downloaded from the distribution apparatus 3 by the data obtaining unit 24. The recording unit 22 is, for example, a folder that stores temporary internet files.

The operation accepting unit 23 accepts viewer's GUI operations performed using a mouse, etc.

Note that, in Embodiment 1, digital content to be generated by the digital content editing apparatus 11 is constituted by a group of files that can be displayed on a web browser, including an HTML file, a JavaScript file (JavaScript is a registered trademark, and description thereof is hereinafter omitted.), a style sheet file, a video file, an audio file, an image file, a text file, etc.

The video file is a file obtained by an external apparatus such as a video camera, and processed by the digital content editing apparatus 11.

A key file may be a file in any format such as an HTML file, a JavaScript file, a style sheet file, a video file, an image file, or a text file.

FIG. 4 is a diagram describing a hardware configuration of the authoring apparatus 1 according to Embodiment 1 of Embodiment 1.

As shown in FIG. 4, the authoring apparatus 1 includes a CPU 41 for processing instructions of various programs; a ROM 42 for storing programs, such as a control program for the authoring apparatus 1; a RAM 43 that is used for temporarily storing intermediate results of operations performed by the CPU 41, etc., and is writable and readable at high speed; a communication I/F apparatus 44 for communicating with the distribution apparatus 3; an HDD 45; an input apparatus 46 to which various instructions from a creator are inputted; a drive apparatus 47; an information input I/F apparatus 48; and a display apparatus 49.

The CPU 41 performs various processes, according to a program stored in the ROM 42, a program stored in the HDD 45, or a program stored in the RAM 43. In addition, the CPU 41 instructs the RAM 43 or the HDD 45 to temporarily store the data that is required for each process. The CPU 41 performs overall control of the authoring apparatus 1.

Namely, the digital content generating unit 111 and the encrypting unit 112 of the digital content editing apparatus 11, the input/output unit 12, and the operation accepting unit 13 are embodied by a processing circuit, such as the CPU 41 or a system LSI.

In addition, the above-described functions may be performed by a plurality of processing circuits cooperating with each other.

The communication I/F apparatus 44 processes inputs from and outputs to a network.

The input apparatus 46 includes, for example, a numeric keypad and a keyboard. Through the input apparatus 46, inputs from the creator, such as GUI operations, and data are inputted. That is, the input apparatus 46 embodies the operation accepting unit 13.

Operation instructions and data inputted by the creator through the input apparatus 46 are stored in the RAM 43 or the HDD 45.

The HDD 45 is fabricated with, for example, a magnetic memory, and stores, for example, software which is a group of programs required for various processes performed by the CPU 41. Note that the programs that constitute software of various processes performed by the CPU 41 may be embedded in advance in the computer as dedicated hardware or may be embedded in advance in the ROM 42 or the HDD 45.

The drive apparatus 47 connects to the recording medium 4, as required, and copy an encrypted video file to the recording medium 4.

The information input I/F apparatus 48 is a communication I/F for establishing a connection with an external apparatus. The information input I/F apparatus 48 is controlled by the CPU 41, and forms a communication I/F that uses Bluetooth (registered trademark), infrared communication, a USB, a cradle, an SD card, a contact IC card, a contactless IC card, etc. Through the information input I/F apparatus 48 data, such as video, audio, and text, are inputted from an external apparatus, such as a video camera. Note that data, such as video, audio, and text, may be inputted using the drive apparatus 47. Note also that data, such as video, audio, and text, may be inputted through the communication I/F apparatus 44.

The information input I/F apparatus 48 and the drive apparatus 47 embody the input/output unit 12.

The display apparatus 49 is a display apparatus for outputting various information, and includes, for example, a liquid crystal display (LCD), a plasma display panel (PDP), or a cathode-ray tube (CRT) display. For example, the creator inputs GUI operations, data, etc., with the input apparatus 46 while checking display on the display apparatus 49.

FIG. 5 is a diagram describing a hardware configuration of the display apparatus 2 of Embodiment 1.

As shown in FIG. 5, the display apparatus 2 includes a CPU 51 for processing instructions of various programs; a ROM 52 for storing programs, such as a control program for the display apparatus 2; a RAM 53 that is used for temporarily storing intermediate results of operations performed by the CPU 51, etc., and is writable and readable at high speed; a communication I/F apparatus 54 for communicating with the distribution apparatus 3; an input apparatus 55 various instructions from a viewer are inputted; an HDD 56; a drive apparatus 57 for accepting, as input, information from the recording medium 4; and a display apparatus 58.

The CPU 51 performs various processes, according to a program stored in the ROM 52, a program stored in the HDD 56, or a program stored in the RAM 53. In addition, the CPU 51 instructs the RAM 53 to temporarily store the data that is required for each process. The CPU 51 performs overall control of the display apparatus 2.

Namely, the decrypting unit 211 and the playback unit 212 of the digital content playback apparatus 21, the operation accepting unit 23, and the data obtaining unit 24 are embodied by a processing circuit, such as the CPU 41 or a system LSI.

In addition, the above-described functions may be performed by a plurality of processing circuits cooperating with each other.

The communication I/F apparatus 54 processes inputs from and outputs to a communication network.

The input apparatus 55 includes, for example, a numeric keypad and a keyboard. Through the input apparatus 55 various instructions, such as read/write instructions to the recording medium 4, and data from the viewer are inputted. That is, the input apparatus 55 embodies the operation accepting unit 23. The instructions and data inputted by the viewer through the input apparatus 55 are stored in the RAM 53 or the HDD 56.

The HDD 56 is fabricated with, for example, a magnetic memory, and stores, for example, software which is a group of programs required for various processes performed by the CPU 51. Note that the programs that constitute software of various processes performed by the CPU 51 may be embedded in advance in the computer as dedicated hardware or may be embedded in advance in the ROM 52 or the HDD 56.

Note also that the above-described programs may be obtained from a recording medium. For example, a recording medium or memory card having recorded therein the above-described programs may be connected to the drive apparatus 57 as appropriate, and computer programs read therefrom may be installed on the HDD 56 as necessary.

The recording unit 22 uses the HDD 56. Note that this is merely an example and the recording unit 22 may be embodied as a DVD, a memory, etc.

The drive apparatus 57 connects to the recording medium. 4, as required, and obtain an encrypted video file which is pre-recorded on the recording medium 4.

The display apparatus 58 is a display apparatus for outputting various information, and includes, for example, a liquid crystal display (LCD), a plasma display panel (PDP), or a cathode-ray tube (CRT) display.

Next, the operation of the digital content encrypting/decrypting system 100 according to Embodiment 1 of the invention will be described.

The operation of the digital content encrypting/decrypting system 100 can be broadly divided into an operation for generation of digital content and an operation for viewing of digital content. Accordingly, here, a digital content creating operation by the authoring apparatus 1 and a digital content viewing operation by the display apparatus 2 will be described separately.

Note that in the following description, as an example, it is assumed that educational material content such as a web learning material is provided as digital content to a viewer.

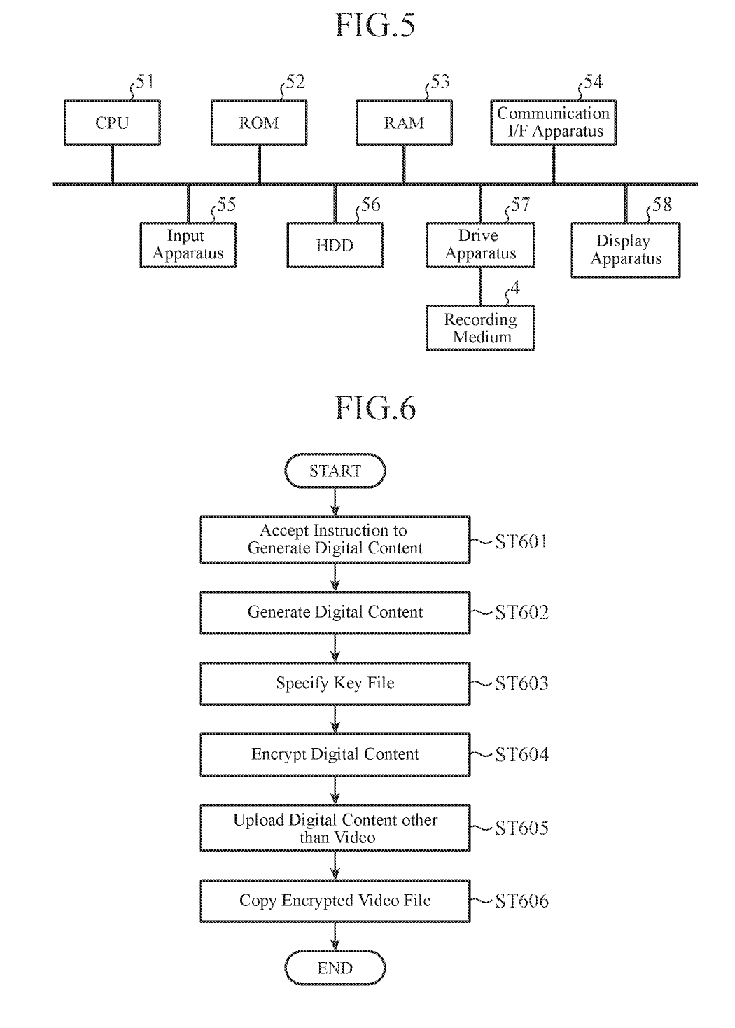

FIG. 6 is a flowchart describing the operation of the authoring apparatus 1 on which the digital content editing apparatus 11 according to Embodiment 1 of the invention is mounted.

The operation accepting unit 13 accepts an instruction on generating digital content from a creator (step ST601).

At this time, the creator designates data, such as video, audio, and text which are the sources of digital content, a video file to be encrypted, and a key file to be used in encrypting the video file.

When the input/output unit 12 accepts and loads the data, such as video, audio, and text designated by the creator from an external apparatus, such as a video camera, and outputs the data to the digital content editing apparatus 11, the digital content generating unit 111 of the digital content editing apparatus 11 generates digital content constituted by a group of files on the basis of the data obtained from the input/output unit 12 according to the instruction accepted by the operation accepting unit 13 from the creator at step ST601 (step ST602). Specifically, in the digital content generating unit 111, the CPU 41 reads a program stored in the ROM 42 or the HDD 45 according to the accepted instruction, and generates digital content according to the read program.

The key file specifying unit 1121 in the encrypting unit 112 of the digital content editing apparatus 11 specifies a file to be used as a key file from the group of files of the digital content generated by the digital content generating unit 111 at step ST602 (step ST603).

The digital content is constituted by a group of files, such as an HTML file, a JavaScript file, a style sheet file, a video file, an audio file, an image file, and a text file. The key file specifying unit 1121 specifies a file to be used as a key file from among the group of files constituting the educational material content, by specifying a file path. Note that which file to use as a key file is selected by the creator, and the key file specifying unit 1121 specifies, as a key file, the file selected by the creator from among the files constituting the educational material content. Note also that the number of files used as key files is not limited to one and may be plural.

The encrypting unit 112 encrypts a video file included in the digital content which is generated by the digital content generating unit 111 at step ST601, using the key file specified by the key file specifying unit 1121 at step ST603 (step ST604). Note that the encrypting unit 112 follows a creator's instruction on which video file to encrypt among video files included in the digital content. Note also that the number of encryption target files serving as encryption targets is not limited to one and may be plural.

Here, the encrypting unit 112 does not output an unencrypted video file as digital content, or outputs an unencrypted video file and then deletes the unencrypted video file.

In addition, the digital content whose video file has been encrypted is saved in an internal memory, the HDD 45, or the like.

Note that although here the encrypting unit 112 follows a creator's instruction on which video file to encrypt among video files included in the digital content, the configuration is not limited thereto. For example, all video files may be forcefully encrypted, or the creator may select either encryption or no encryption of all video files.

The input/output unit 12 uploads digital content other than the video file that is encrypted by the encrypting unit 112 at step ST604, i.e., digital content other than video (including the key file), to the distribution apparatus 3 using, for example, FTP client software installed on the authoring apparatus 1 and an FTP server configured in the distribution apparatus 3 (step ST605).

The input/output unit 12 copies the video file encrypted by the encrypting unit 112 at step ST604, i.e., the encrypted video file, to the recording medium 4 using, for example, a writing function provided in the OS or commercial writing software (step ST606).

Note that when the encrypting unit 112 encrypts, at step ST604, a video file of the digital content generated by the digital content generating unit 111 at step ST602, an unencrypted video file is not outputted as digital content or is outputted and then deleted. Thus, even when digital content files are stored in the same folder and outputted, an unencrypted video file can be prevented from being erroneously uploaded to the distribution apparatus 3 or copied to the recording medium 4.

Note also that although here the creator selects which file to use as a key file and the key file specifying unit 1121 specifies, at step ST603, the selected key file from among the group of files included in the digital content, the configuration is not limited thereto.

For example, the key file specifying unit 1121 may randomly select one or a plurality of files from among the group of files included in the digital content, and specify the selected file(s) as a file(s) to be used as a key file(s). By this, the creator does not need to select a key file. In addition, since which file has been used as a key file is secret, it is difficult to identify the key file, thus strengthening the security of an encrypted file.

In addition, although here a creator's instruction is followed on which video file to encrypt, the configuration is not limited thereto.

For example, the encrypting unit 112 may further include an encryption target file selecting unit (not shown) that selects one or a plurality of encryption target files from among the group of files constituting the digital content, and when encryption is performed at step ST604, the encrypting unit 112 may encrypt the one or plurality of encryption target files selected by the encryption target file selecting unit. Note that for which video file to select as an encryption target file by the encryption target file selecting unit, for example, the encryption target file selecting unit may forcefully encrypt all video files. By this, encryption of video files can be performed without the need for the creator to select an encryption target video file. In addition, by the configuration in which all video files are encrypted, creator's failure to perform encryption can be prevented.

In addition, it is also possible to provide means for checking, when an encrypted video file having been outputted once is re-outputted, whether a change has been made to data in the encrypted video file or whether a change has been made by the digital content generating unit 111.

Specifically, since digital content whose video file is encrypted is saved each time the video file is encrypted, a comparison with already outputted digital content can be made using files of the saved digital content.

In addition, whether the digital content generating unit 111 has performed a change operation to an encryption target file can be checked.

By this, control can be performed such that when an encrypted video file is re-outputted, if there is no change in data in the encrypted file or a change operation to an encryption target file has not been performed, then the encrypted video file is not updated, and only when there is a change, the data in the encrypted video file is re-outputted. Thus, re-output processing time can be reduced for when there is no change in the data in the encrypted video file.

Note that when digital content other than video is uploaded to the distribution apparatus 3 at step ST605, in the distribution apparatus 3 the digital content is uploaded to a folder open to a network such as a company intranet. In Embodiment 1, since files of digital content other than video are uploaded, the upload transfer time is small and the hardware capacity of the distribution apparatus 3 can also be reduced.

In addition, for example, once the distribution apparatus 3 has completed distribution of digital content to the display apparatus 2, even if the display apparatus 2 has an encrypted video file, the display apparatus 2 cannot acquire the key file and thus cannot decrypt the encrypted video file. Thus, digital content can be made open for a limited period. Note that details of the process of decrypting the encrypted video file using the key file by the display apparatus 2 will be described later.

In addition, for example, the distribution apparatus 3 may be set up under a user authentication server so that only users that log in using their employee ID cards, etc., can access digital content.

In addition, for example, a digital content viewing log may be managed by recording an access log on the distribution apparatus 3.

In addition, when the encrypted video file is copied at step ST606, the recording medium 4 stores the encrypted video file. Since the encrypted video file is encrypted using not only a password but also the key file, even if a third party acquires the recording medium 4 and the password, the third party cannot decrypt unless acquiring the key file from the distribution apparatus 3.

In addition, even if the third party acquires the recording medium 4, the password, and the key file, the third party cannot decrypt unless having a decrypting apparatus.

In addition, even if the third party acquires the recording medium 4, the password, the key file, and the decrypting apparatus, since the decrypting apparatus is configured to automatically obtain a key file, the third party cannot decrypt unless analyzing how the decrypting apparatus refers to the key file.

In addition, for example, the recording medium 4 to be distributed can also store therein access means for accessing the distribution apparatus 3 to download digital content. By this, the viewer can start viewing digital content only by inserting the recording medium 4 into the display apparatus 2 and executing the access means, without the need for the viewer to be aware of matching between digital content other than video on the distribution apparatus 3 and a video file in the recording medium 4. The digital content viewing operation of the display apparatus 2 will be described later.

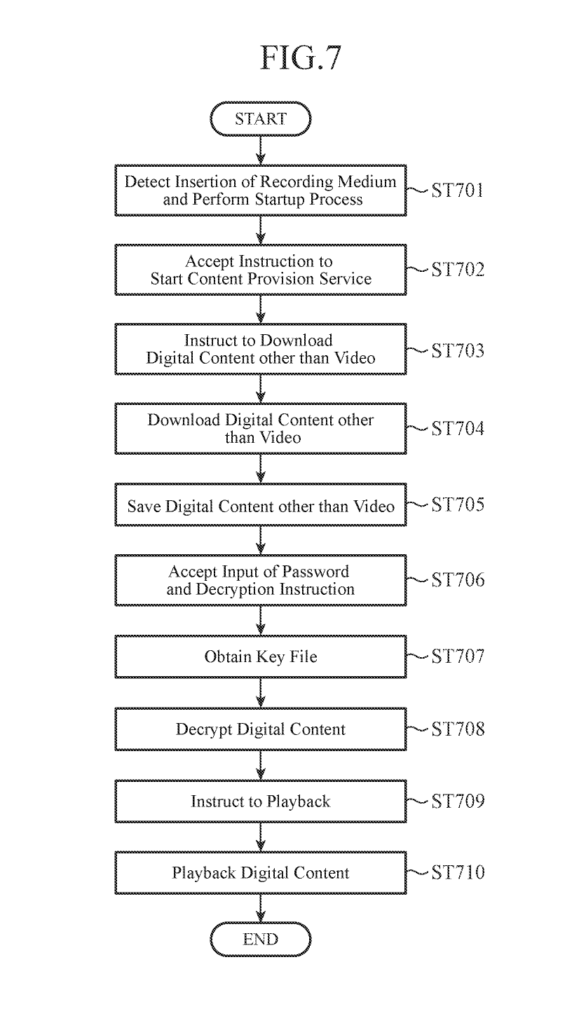

FIG. 7 is a flowchart describing the operation of the display apparatus 2 according to Embodiment 1 of the invention.

The display apparatus 2 detects insertion of the recording medium 4 and performs a startup process (step ST701). Specifically, when a viewer inserts the recording medium 4 into the display apparatus 2, in the display apparatus 2 the CPU 51 reads a program stored in the ROM 52 or the HDD 56 or a program recorded in the recording medium 4, creates, according to the program, a screen for instructing to playback encrypted content which is recorded in the recording medium 4 or to start a content provision service, and instructs the display apparatus 58 to display the screen.

The operation accepting unit 23 accepts an instruction to start a content provision service from the viewer (step ST702).

Specifically, first, when an instruction to select the start of a content provision service is inputted by the viewer using the input apparatus 55, the operation accepting unit 23 accepts the instruction.

When the operation accepting unit 23 accepts the instruction to select the start of a content provision service, subsequently, the CPU 51 reads a program stored in the ROM 52 or the HDD 56 or a program recorded in the recording medium 4, and instructs the data obtaining unit 24 to download digital content other than video from the distribution apparatus 3, according to the program (step ST703).

Based on the instruction to download digital content other than video which is accepted at step ST703, the data obtaining unit 24 accesses digital content other than video on the distribution apparatus 3 to download a group of files of the digital content other than video (step ST704). Specifically, the data obtaining unit 24 downloads web-accessed files. When the data obtaining unit 24 accesses a content startup file stored on a CD or DVD, or an HTML file for accessing the top which is included in a digital content folder from a URL link to an intranet website, etc., the HTML file for accessing the top is downloaded. Thereafter, an HTML file accessed as a result of a screen transition by a script or a viewer's URL click operation is downloaded as appropriate. In addition, a media file such as an audio file is downloaded by a script instruction or a viewer's URL click operation. In addition, for a script file and a style sheet file, related files are downloaded when downloading an HTML file.

The data obtaining unit 24 records, in the recording unit 22, the group of files of the digital content other than video which are downloaded at step ST704 (step ST705).

The CPU 51 reads a program stored in the ROM 52 or the HDD 56 or a program recorded in the recording medium 4, creates, according to the program, a screen requesting an input of a password required for decryption of the recording medium 4 and an instruction to decrypt the recording medium 4, and instructs the display apparatus 58 to display the screen. The operation accepting unit 23 accepts an input of a password and an instruction to decrypt the recording medium 4 from the viewer (step ST706).

The key file obtaining unit 2111 in the decrypting unit 211 of the digital content playback apparatus 21 obtains a key file from the group of files of the digital content other than video which are recorded in the recording unit 22 (step ST707). Specifically, for example, when a fixed key file is used, the key file obtaining unit 2111 obtains a key file based on information indicating which file to use as a key file, which is defined in advance in the digital content editing apparatus 11 and the digital content playback apparatus 21. In addition, for example, when a variable key file is used, since a key file is determined upon creation, information for identifying the key file is recorded in digital content other than video which is uploaded to the distribution apparatus 3, or in a filename of an encrypted file which is encrypted and distributed by the recording medium 4 or a filename of a startup file, or the like, in a format that a third party cannot figure out, such as a sequence of numbers. Then, the key file obtaining unit 2111 reads the information and thereby obtains the key file.

The decrypting unit 211 obtains the encrypted video file that is loaded from the recording medium 4 at step ST701, and decrypts the encrypted video file using the password accepted at step ST706 and the key file obtained by the key file obtaining unit 2111 at step ST707 (step ST708).

When the decrypting unit 211 completes the decryption at step ST708, the decrypting unit 211 instructs the playback unit 212 to playback the digital content (step ST709).

The playback unit 212 of the digital content playback apparatus 21 integrates the video file decrypted by the decrypting unit 211 at step ST708 and the group of files of the digital content other than video which are recorded in the recording unit 22 to playback the integrated digital content and instruct the display apparatus 58 to display the digital content (step ST710). Specifically, the playback unit 212 integrates the decrypted video file which is referred to by the video referring unit 2121 and the group of files of the digital content other than video, and thereby plays back digital content.

Thus, in Embodiment 1, when the viewer views digital content, in the display apparatus 2, the decrypting unit 211 automatically obtains a file used as the key file from the group of files of digital content recorded in the recording unit 22, i.e., the group of files of digital content other than a video file. By this, the creator does not need to distribute a key file separately from digital content nor manage associations between key files and digital content in a database, and thus, the burden of management and operation of digital content can be reduced.

In addition, since the viewer does not need to manually select a key file and can view digital content without the need of a key file setting procedure, a burden upon viewing can be reduced.

In addition, since the presence of a key file can be hidden to viewers, a key file can be prevented from being copied and taken out illicitly by a malicious viewer.

In addition, even if a viewer grasps the presence of a key file, by hiding which file has been used as a key file among the group of files constituting digital content, a key file can be prevented from being copied and taken out illicitly.

In addition, when a plurality of files is used as key file, security can be further strengthened according to the number of combinations of key files.

As described above, according to Embodiment 1, encryption is performed using part of a group of files of digital content as a key file(s), and in decryption, the key file(s) is automatically obtained. By this, encryption and decryption using a key file can be performed only by creating and distributing, by a creator, digital content without separately creating key files and performing management and operation of the key files. Accordingly, the burden of management and operation for when digital content is encrypted and distributed can be reduced. In addition, a viewer can easily view digital content without the need of a key file setting procedure.

### Embodiment 2

In Embodiment 1, digital content is encrypted using part of a group of files of the digital content as a key file(s) when creating the digital content; on the other hand, in Embodiment 2, an embodiment is described in which a virtual disk encryption scheme is used where a protection target file is stored and encrypted in a virtual disk file which can be mounted on a display apparatus 2 as a virtual removable disk.

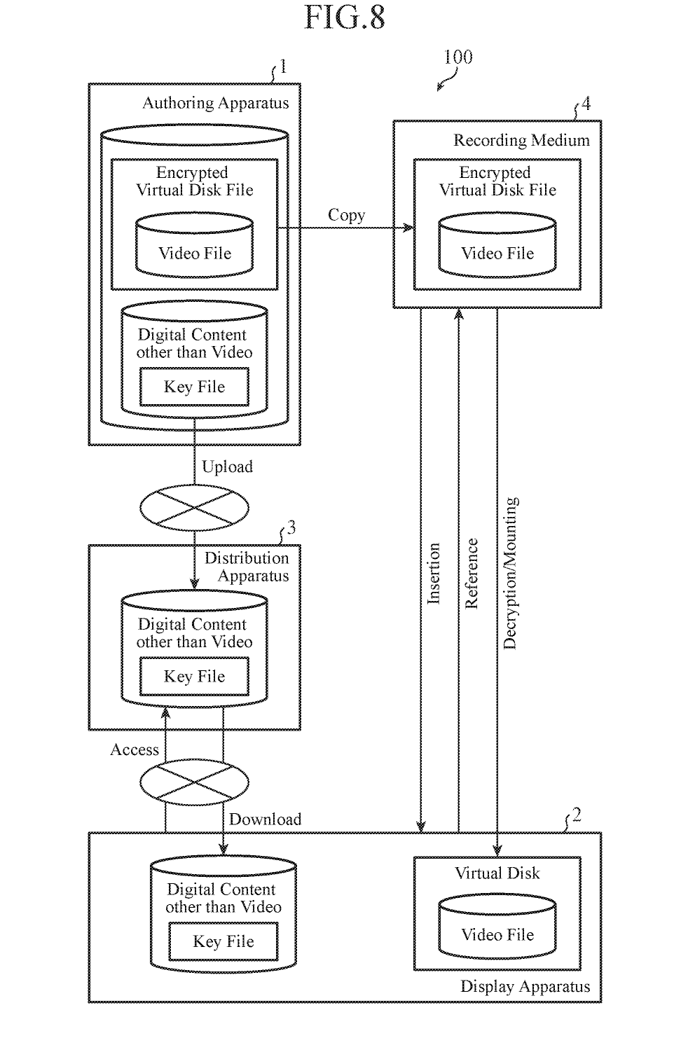

FIG. 8 is diagram describing a configuration of a digital content encrypting/decrypting system 100 according to Embodiment 2 of the invention.

Note that in FIG. 8, as in FIG. 1 described in Embodiment 1, for convenience of description, content data to be exchanged in the digital content encrypting/decrypting system 100 is also shown in FIG. 8.

The overall configuration of the digital content encrypting/decrypting system 100 of Embodiment 2 of the invention in FIG. 8 is the same as that which is described using FIG. 1 in Embodiment 1, and thus, the same reference signs are provided and redundant description is omitted.

The digital content encrypting/decrypting system 100 of Embodiment 2 differs from the digital content encrypting/decrypting system 100 of Embodiment 1 only in the content of content data to be exchanged, and thus, only different parts will be described.

An authoring apparatus 1 stores a video file in a virtual disk file, encrypts the virtual disk file, and copies the encrypted virtual disk file to a recording medium 4, instead of encrypting the video file itself.

A display apparatus 2 accesses a distribution apparatus 3 to download digital content other than video, and also refers to the encrypted virtual disk file in the recording medium 4 to decrypt the encrypted virtual disk file, mounts the virtual disk file as a virtual disk, and plays back digital content.

An overall configuration of the authoring apparatus 1 of Embodiment 2 of the invention is the same as that which is described using FIG. 2 in Embodiment 1, and thus, redundant description is omitted.

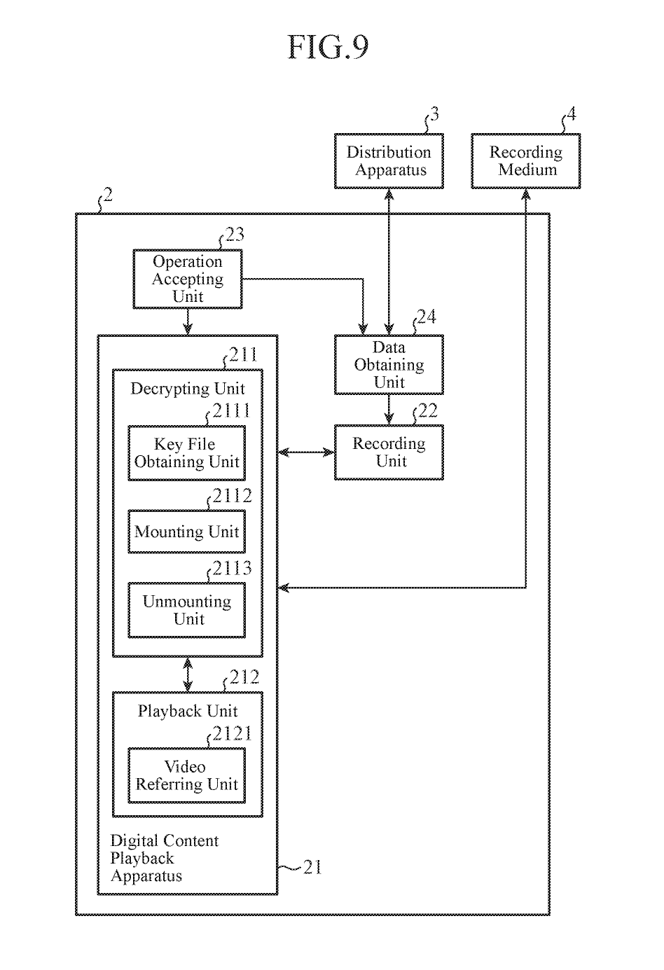

FIG. 9 is a configuration diagram of the display apparatus 2 according to Embodiment 2 of the invention.

The display apparatus 2 shown in FIG. 9 differs from the display apparatus 2 described using FIG. 3 in Embodiment 1 only in that a decrypting unit 211 of a digital content playback apparatus 21 further includes a mounting unit 2112 and an unmounting unit 2113. Other components are the same as those described in FIG. 3 and thus the same reference signs are provided and redundant description is omitted.

The mounting unit 2112 refers to the virtual disk file in the recording medium 4 which is decrypted by the decrypting unit 211, to mount the virtual disk file as a virtual disk in the display apparatus 2.

The unmounting unit 2113 unmounts the virtual disk mounted by the mounting unit 2112 to a state of an encrypted virtual disk file.

The hardware configuration of the authoring apparatus 1 and the display apparatus 2 according to Embodiment 2 are the same as those described using FIGS. 4 and 5 in Embodiment 1, respectively, and thus, redundant description is omitted.

Note that the mounting unit 2112 and the unmounting unit 2113 are implemented by a processing circuit, such as a CPU 51 or a system LSI.

Note also that the above-described functions may be performed by a plurality of processing circuits cooperating with each other.

Next, operations will be described.

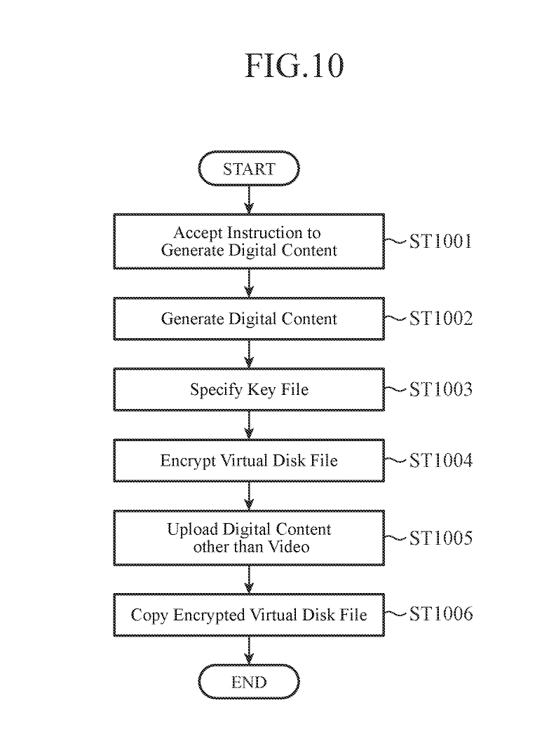

FIG. 10 is a flowchart describing the operation of the authoring apparatus 1 having mounted thereon a digital content editing apparatus 11 according to Embodiment 2 of the invention.

Note that steps ST1002 to ST1003 and ST1005 of FIG. 10 are the same in operation as steps ST602 to ST603 and ST605 of FIG. 6 which are described in Embodiment 1, and thus, redundant description is omitted and only different operations from those of Embodiment 1 will be described below.

An operation accepting unit 13 accepts an instruction to generate digital content from a creator (step ST1001). Specific content is the same as that at step ST601 of FIG. 6 which is described in Embodiment 1. Note, however, that at this step ST1001, the creator specifies the capacity of a virtual disk, in addition to data such as video, audio, and text which are the sources of digital content, a video file to be encrypted, and a key file to be used when encrypting the video file.

When a digital content generating unit 111 creates digital content including a plurality of files at step ST1002 and a key file specifying unit 1121 specifies a key file at step ST1003, an encrypting unit 112 stores, in a virtual disk file, a video file included in the digital content created by the digital content generating unit 111, and encrypts the virtual disk file using the key file selected by the key file specifying unit 1121 (step ST1004).

Although in Embodiment 1 the encrypting unit 112 encrypts a video file itself, in Embodiment 2 the encrypting unit 112 stores a video file in a virtual disk and encrypts the virtual disk file having stored therein the video file, instead of encrypting the video file itself.

Note that at this time the encrypting unit 112 specifies the capacity of the virtual disk file where the video file is stored, according to the capacity of the virtual disk which is accepted from the creator at step ST1001. In addition, a creator's instruction is followed on a video file to be stored in the virtual disk file. In addition, in Embodiment 2, too, as in Embodiment 1, the encrypting unit 112 does not output a video file that is not stored in the virtual disk file when outputting digital content, or outputs the video file and then deletes the video file.

An input/output unit 12 copies the encrypted virtual disk file having stored therein the video file which is encrypted at step ST1004 by the encrypting unit 112 among the digital content saved therein, to the recording medium 4 using, for example, a writing function provided in an OS or commercial writing software (step ST1006).

Note that although here the encrypting unit 112 specifies the capacity of the virtual disk according to the capacity of the virtual disk accepted from the creator, the configuration is not limited thereto. For example, the digital content editing apparatus 11 may further include a virtual disk capacity setting unit (not shown) that determines the capacity of a virtual disk file according to the capacity of a protection target file to be stored in the virtual disk file, i.e., a video file, and the encrypting unit 112 may specify the capacity of a virtual disk according to the capacity determined by the virtual disk capacity setting unit. By this, the capacity of the virtual disk can be automatically set without the creator specifying it.

When digital content other than video is uploaded to the distribution apparatus 3 at step ST1005, in the distribution apparatus 3 the digital content is uploaded to a folder open to a network such as a company intranet. A specific operation is the same as that of Embodiment 1.

When the encrypted video file is copied at step ST1006, the recording medium 4 stores the encrypted video file. A specific operation is the same as that of Embodiment 1.

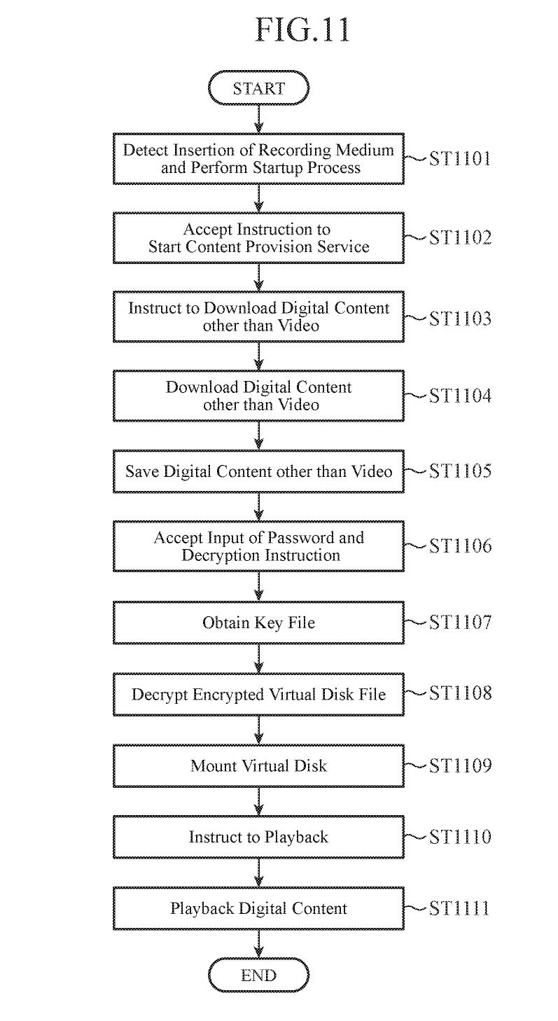

FIG. 11 is a flowchart describing the operation of the display apparatus 2 according to Embodiment 2 of the invention.

Note that steps ST1101 to ST1107 in FIG. 11 are the same in operation as steps ST701 to ST707 of FIG. 7 which are described in Embodiment 1, and thus, redundant description is omitted and only different operations from those of Embodiment 1 will be described below.

The decrypting unit 211 decrypts an encrypted virtual disk file which is loaded from the recording medium 4 at step ST1101, using a password accepted by a viewer's input on a password input screen at step ST1106 and a key file obtained by a key file obtaining unit 2111 at step ST1107 (step ST1108).

The mounting unit 2112 in the decrypting unit 211 of the digital content playback apparatus 21 refers to the virtual disk file decrypted by the decrypting unit 211 at step ST1108, to mount the virtual disk file as a virtual disk on the display apparatus 2 (step ST1109).

When the decrypting unit 211 decrypts the virtual disk file at step ST1108 and mounts the decrypted virtual disk file as a virtual disk at step ST1109, the decrypting unit 211 provides an instruction to playback digital content to a playback unit 212 (step ST1110). A specific operation is the same as that at step ST709 of FIG. 7.

The playback unit 212 of the digital content playback apparatus 21 integrates a video file stored in the virtual disk which is mounted on the display apparatus 2 by the mounting unit 2112 at step ST1109 and a group of files of digital content other than video which are recorded in a recording unit 22, and thereby plays back the integrated digital content, and allows a display apparatus 58 to display the digital content (step ST1111).

Note that after playing back the digital content, the virtual disk mounted by the mounting unit 2112 at step ST1109 is unmounted by the unmounting unit 2113 in the decrypting unit 211 and goes back to a state of an encrypted virtual disk file.

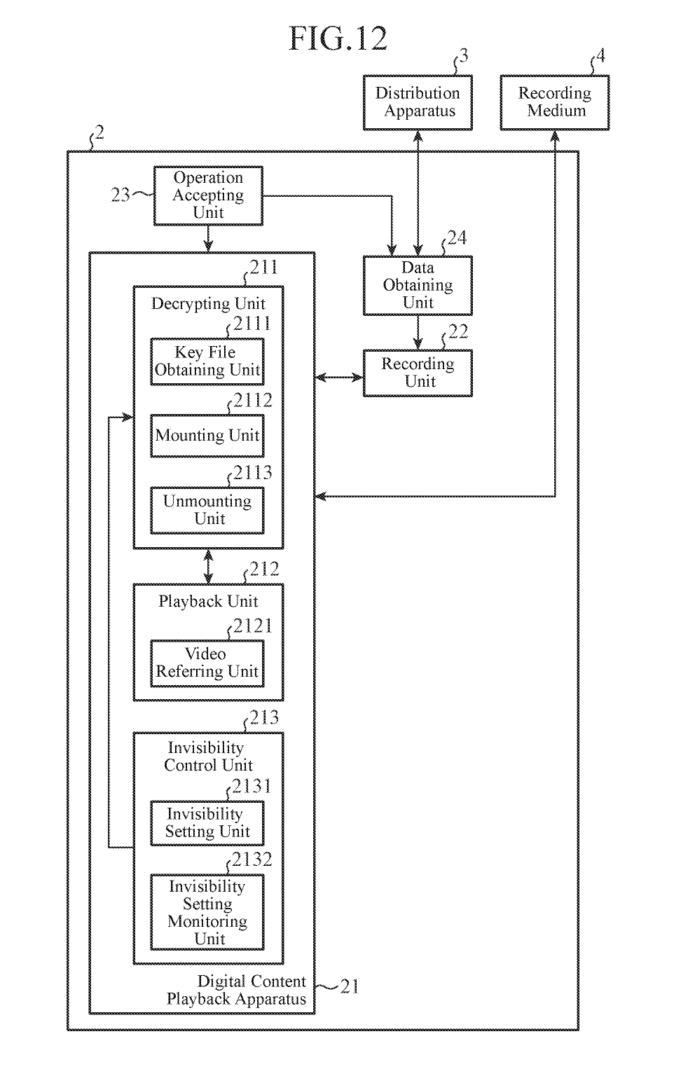

In addition, in Embodiment 2, in addition to the above-described configuration, for example, as shown in FIG. 12, the digital content playback apparatus 21 of the display apparatus 2 may be configured to further include an invisibility control unit 213 including an invisibility setting unit 2131 and an invisibility setting monitoring unit 2132, and the invisibility setting unit 2131 may rewrite registry settings while a virtual disk is being mounted, to make a drive having mounted thereon the virtual disk invisible. By this, a file in the virtual disk can be prevented from being browsed and copied while the virtual disk is being mounted.

In addition, when the invisibility setting monitoring unit 2132 monitors a setting item of the registry that makes the virtual disk invisible, and determines that the setting item for invisibility has been rewritten, the decrypting unit 211 may instruct the unmounting unit 2113 to forcefully unmount the virtual disk. By this, when an invisibility setting has been cancelled, too, the invisibility setting monitoring unit 2132 determines that the invisibility setting has been cancelled, and thus, the decrypting unit 211 allows the unmounting unit 2113 to unmount the virtual disk, by which a file in the virtual disk can be protected.

In addition, the mounting unit 2112 may mount a virtual disk on any drive. In that case, in addition to the above-described configuration, the digital content playback apparatus 21 of the display apparatus 2 may further include a drive letter obtaining unit (not shown) that obtains a drive letter of a drive mounted by the mounting unit 2112. By this, the decrypting unit 211 transmits information on the obtained drive letter to the distribution apparatus 3, and can thereby dynamically generate a path where a video file is referred to from digital content.

Normally, when a video file itself is encrypted, if digital content includes a plurality of video files, then a decryption process is performed every time a video file is referred to from the digital content, causing a time lag at the start of playback due to the decryption process.

In addition, since a decrypted file is saved in an unencrypted state on the HDD, etc., the file can be browsed and copied by a viewer.

On the other hand, for encryption using a virtual disk, since a video file itself after decryption of the virtual disk is not encrypted, even when a plurality of pieces of video are included in digital content, playback can start without a decryption process. In addition, for the virtual disk, decrypted data can only be accessed by accessing a drive where the virtual disk is mounted, and after unmounting, the decrypted data is not left on the HDD, etc.

Hence, by making the drive where the virtual disk is mounted invisible, browsing and copying by a viewer can be prevented.

As described above, according to Embodiment 2, as in Embodiment 1, encryption is performed using part of a group of files of digital content as a key file(s), and the key file(s) is automatically obtained in decryption. By this, encryption and decryption using a key file can be performed only by creating and distributing, by a creator, digital content without separately creating key files and performing management and operation of the key files. Accordingly, the burden of management and operation in encrypting and distributing digital content can be reduced. In addition, a viewer can easily view digital content without the need of a key file setting procedure.

### Embodiment 3

In Embodiment 1, an embodiment is described in which the digital content playback apparatus 21 of the display apparatus 2 includes therein the decrypting unit 211 and the playback unit 212, and the digital content playback apparatus 21 performs decryption of a video file and playback of digital content; on the other hand, in embodiment 3, an embodiment is described in which a digital content decrypting apparatus is provided separately from the digital content playback apparatus 21, and the digital content playback apparatus 21 does not perform decryption, but performs control of a decryption process performed by the digital content decrypting apparatus.

An overall configuration of a digital content encrypting/decrypting system 100 including an authoring apparatus 1 having mounted thereon a digital content editing apparatus 11 according to Embodiment 3 and content data to be exchanged in the digital content encrypting/decrypting system 100 are the same as those described using FIG. 1 in Embodiment 1, and thus, redundant description is omitted.

In addition, an overall configuration of the authoring apparatus 1 having mounted thereon the digital content editing apparatus 11 according to Embodiment 3 is also the same as that described using FIG. 2 in Embodiment 1, and thus, redundant description is omitted.

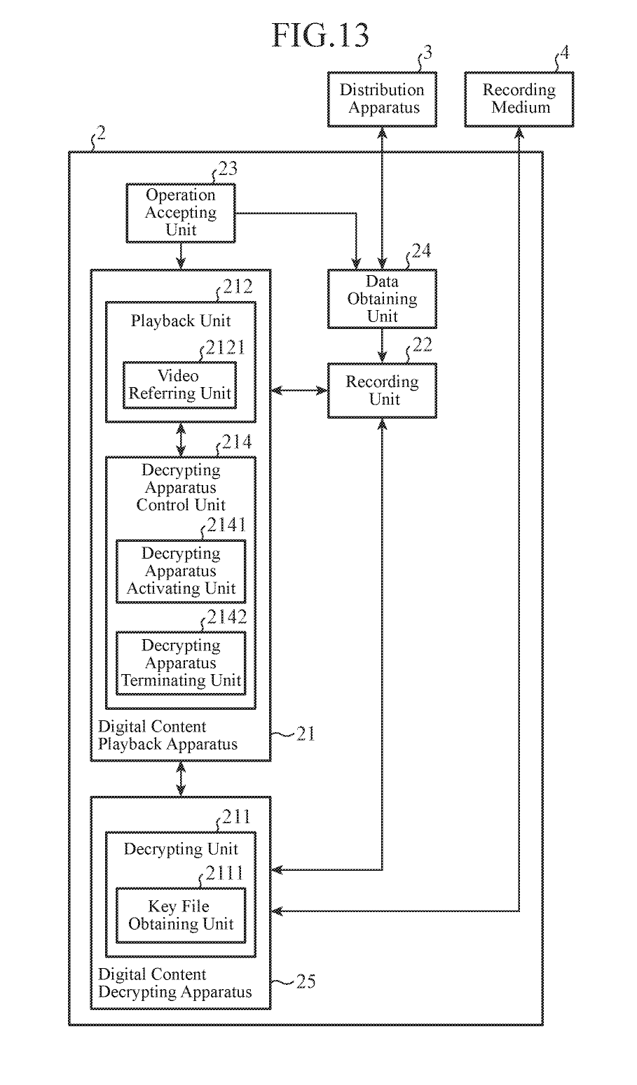

FIG. 13 is a configuration diagram of a display apparatus 2 of Embodiment 3 of the invention.

The display apparatus 2 shown in FIG. 13 differs from the display apparatus 2 described using FIG. 3 in Embodiment 1 in that the display apparatus 2 further includes a digital content decrypting apparatus 25 and that the digital content decrypting apparatus 25 includes a decrypting unit 211. In addition, a digital content playback apparatus 21 differs in that the digital content playback apparatus 21 includes a decrypting apparatus control unit 214 instead of the decrypting unit 211.

Other components are the same as those of the display apparatus 2 described using FIG. 3 in Embodiment 1, and thus, the same components are denoted by the same reference signs and redundant description is omitted.

In FIG. 13, the decrypting unit 211 and a key file obtaining unit 2111 which are included in the digital content decrypting apparatus 25 are the same as the decrypting unit 211 and the key file obtaining unit 2111 which are described in Embodiment 1, and the place where the decrypting unit 211 is provided is just changed from the digital content playback apparatus 21 to the digital content decrypting apparatus 25.

The decrypting apparatus control unit 214 includes a decrypting apparatus activating unit 2141 and a decrypting apparatus terminating unit 2142.

The decrypting apparatus activating unit 2141 outputs an instruction signal to start a decryption process to the digital content decrypting apparatus 25.

The decrypting apparatus terminating unit 2142 outputs an instruction signal to end the decryption process to the digital content decrypting apparatus 25.

The hardware configuration of the authoring apparatus 1 and the display apparatus 2 of Embodiment 3 are the same as those described using FIGS. 4 and 5 in Embodiment 1, respectively, and thus, redundant description is omitted.

Note that the decrypting apparatus activating unit 2141 and the decrypting apparatus terminating unit 2142 are implemented by a processing circuit such as a CPU 51 or a system LSI.

Note also that the above-described functions may be performed by a plurality of processing circuits cooperating with each other.

Next, operations will be described.

Note that the operation of the authoring apparatus 1 according to Embodiment 3 of the invention is the same as that described using FIG. 6 in Embodiment 1, and thus, redundant description is omitted.

The operation of a distribution apparatus 3 performed when digital content other than video is uploaded to the distribution apparatus 3 and the operation of a recording medium 4 performed when an encrypted video file is copied are also the same as those of Embodiment 1.

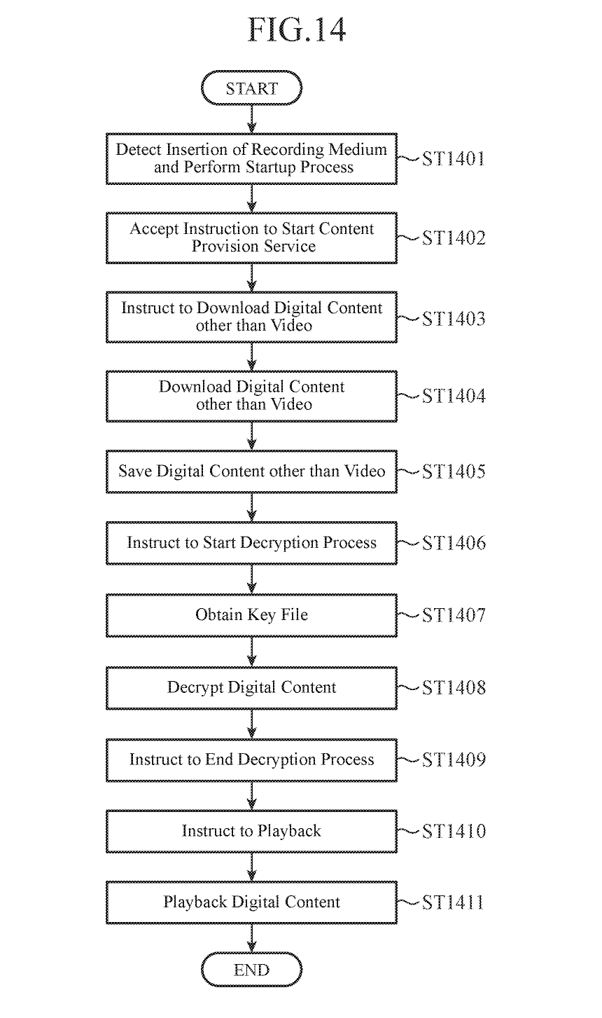

FIG. 14 is a flowchart describing the operation of the display apparatus 2 according to Embodiment 3 of the invention.

Note that steps ST1401 to ST1405, ST1407, ST1408, ST1410, and ST1411 in FIG. 14 are the same in operation as steps ST701 to ST705, ST707, ST708, ST709, and ST710 of FIG. 7 which are described in Embodiment 1, and thus, redundant description is omitted and only different operations from those of Embodiment 1 will be described below.

When a data obtaining unit 24 records downloaded digital content other than video in a recording unit 22 at step ST1405, the decrypting apparatus activating unit 2141 in the decrypting apparatus control unit 214 of the digital content playback apparatus 21 outputs an instruction signal to start a decryption process to the digital content decrypting apparatus 25 (step ST1406). In addition, at this time, the CPU 51 reads a program stored in a ROM 52 or an HDD 56 or a program recorded in the recording medium 4, creates, according to the program, a screen requesting an input of a password required for decryption of the recording medium 4 and an instruction to decrypt the recording medium 4, and allows a display apparatus 58 to display the screen, and accepts an input of a password from the viewer.

When the digital content decrypting apparatus 25 receives the instruction signal to start a decryption process, the decrypting unit 211 decrypts an encrypted video file using the password accepted at step ST1406 and a key file obtained by the key file obtaining unit 2111 referring to the recording unit 22 at step ST1407 (step ST1408), and outputs the decrypted video file to the digital content playback apparatus 21.

Note that specific operations at steps ST1407 and ST1408 are the same as those at steps ST707 and ST708 of FIG. 7.

When the decrypted video file is outputted from the digital content decrypting apparatus 25, the decrypting apparatus terminating unit 2142 in the decrypting apparatus control unit 214 of the digital content playback apparatus 21 outputs an instruction signal to end the decryption process to the digital content decrypting apparatus 25 (step ST1409).

As such, in Embodiment 3, the digital content playback apparatus 21 and the digital content decrypting apparatus 25 are provided as separate apparatuses. By this, the digital content playback apparatus 21 can be configured by a script such as JavaScript that can be delivered over a network and browsed using a web browser, and an encrypted file can be decrypted using the digital content decrypting apparatus 25 which is separately mounted on the display apparatus 2.

By this, a playback unit having different requests for different provision destinations, such as a screen layout, playback control, and what medium to use, can be developed separately from a decrypting unit.

In addition, by providing, in the digital content playback apparatus 21, the decrypting apparatus control unit 214 that starts and terminates the activation of the digital content decrypting apparatus 25, the digital content decrypting apparatus 25 can be controlled in conjunction with the digital content playback apparatus 21. By this, a viewer needs only to perform an operation for playback of digital content and does not need to be aware of decryption.

Note that although here it is described that Embodiment 3 is applied to Embodiment 1, the configuration is not limited thereto. By applying Embodiment 3 to Embodiment 2, for example, the decrypting unit 211 described in FIG. 13 can also be configured to further include a mounting unit 2112 and an unmounting unit 2113.

As described above, according to Embodiment 3, as in Embodiment 1, encryption is performed using part of a group of files of digital content as a key file(s), and the key file(s) is automatically obtained in decryption. By this, encryption and decryption using a key file can be performed only by creating and delivering, by a creator, digital content without separately creating key files and performing management and operation of the key files. Accordingly, the burden of management and operation in encrypting and distributing digital content can be reduced. In addition, a viewer can easily view digital content without the need of a key file setting procedure.

In addition, since a decryption process is automatically performed, the viewer needs only to perform an operation for playback of digital content and does not need to be aware of decryption.

Note that free combinations of the embodiments, or modifications to any component in the embodiments, or omissions of any component in the embodiments may be made within the spirit and scope of the invention.

### INDUSTRIAL APPLICABILITY

According to a digital content editing apparatus, a digital content playback apparatus, a digital content decrypting apparatus, a digital content encrypting/decrypting system, and a digital content encrypting/decrypting method of the invention, it is configured such that encryption is performed using some of digital content files as a key file(s), and upon decryption, the key file(s) is automatically obtained. Thus, encryption and decryption using a key file can be performed by creating and delivering, by a creator, digital content without separately creating key files, and accordingly, the burden of management and operation for when digital content is encrypted and distributed can be reduced. Therefore, the apparatuses, system, and method are suitable for securely delivering digital content including video, audio, text, etc.

### REFERENCE SIGNS LIST

1: Authoring apparatus, 2: Display apparatus, 3: Distribution apparatus, 4: Recording medium, 11: Digital content editing apparatus, 12: Input/output unit, 13: Operation accepting unit, 21: Digital content playback apparatus, 22: Recording unit, 23: Operation accepting unit, 24: Data obtaining unit, 25: Digital content decrypting apparatus, 41 and 51: CPU, 42 and 52: ROM, 43 and 53: RAM, 44 and 54: Communication I/F apparatus, 45 and 56: HDD, 46 and 55: Input apparatus, 47 and 57: Drive apparatus, 48: Information input I/F apparatus, 49: Display apparatus, 58: Display apparatus, 111: Digital content generating unit, 112: Encrypting unit, 211: Decrypting unit, 212: Playback unit, 213: Invisibility control unit, 1121: Key file specifying unit, 2111: Key file obtaining unit, 2112: Mounting unit, 2113: Unmounting unit, 2121: Video referring unit, 2131: Invisibility setting unit, 2132: Invisibility setting monitoring unit, 2141: Decrypting apparatus activating unit, and 2142: Decrypting apparatus terminating unit

1.-16. (canceled)

17. A digital content editing apparatus comprising:
a processor to execute a program; and
a memory to store the program which, when executed by the processor, performs processes of,
processing data and generating digital content constituted by a group of files, and
encrypting a group of encryption target files among the group of files constituting the digital content, using a part of a group of non-encryption target files among the group of files constituting the generated digital content.

18. The digital content editing apparatus according to claim 17, wherein the processes further comprise,
selecting one or more key files from among the group of non-encryption target files, and encrypting the group of encryption target files using the selected one or more key files.

19. The digital content editing apparatus according to claim 17, wherein the processes further comprise,
selecting one or more encryption target files from among the group of files constituting the generated digital content, and encrypting the selected one or more encryption target files.

20. The digital content editing apparatus according to claim 17, wherein the processes further comprise,
storing, in a virtual disk file, the encryption target files from among the group of files constituting the generated digital content, and encrypting the virtual disk file.

21. The digital content editing apparatus according to claim 20, wherein the processes further comprise, determining a capacity of the virtual disk file according to a capacity of the encryption target file.

22. A web content playback apparatus comprising:
a processor to execute a program; and
a memory to store the program which, when executed by the processor, performs processes of,
decrypting, using a part of a group of web content files that are unencrypted and distributed from a web content editing apparatus, a group of web content files that are obtained through a recording medium and encrypted by the web content editing apparatus, and
integrating the group of unencrypted web content files and the decrypted group of web content files, and allowing a display apparatus to playback the integrated web content files.

23. A digital content playback apparatus comprising:
a processor to execute a program; and
a memory to store the program which, when executed by the processor, performs processes of,
decrypting, using a part of a group of digital content files that are unencrypted and distributed from a digital content editing apparatus, a group of digital content files that are obtained through a recording medium and encrypted by the digital content editing apparatus, and
integrating the group of unencrypted digital content files and the decrypted group of digital content files, and allowing a display apparatus to playback the integrated digital content files,
wherein the processes further comprise,
obtaining a key file from among the group of unencrypted digital content files, and decrypting the group of encrypted digital content files by using the obtained key file.

24. A digital content playback apparatus comprising:
a processor to execute a program; and
a memory to store the program which, when executed by the processor, performs processes of,
decrypting, using a part of a group of digital content files that are unencrypted and distributed from a digital content editing apparatus, a group of digital content files that are obtained through a recording medium and encrypted by the digital content editing apparatus, and
integrating the group of unencrypted digital content files and the decrypted group of digital content files, and allowing a display apparatus to playback the integrated digital content files,
wherein the processes further comprise,
obtaining a key file from among the group of unencrypted digital content files, and decrypting a virtual disk file storing the group of encrypted digital content files by using the obtained key file.

25. The digital content playback apparatus according to claim 24, wherein the processes further comprise,
referring to the decrypted virtual disk file to mount the virtual disk file as a virtual disk, and
unmounting the mounted virtual disk to a state of an encrypted virtual disk file.

26. The digital content playback apparatus according to claim 25, wherein the processes further comprise,
obtaining a drive letter of a drive on which the virtual disk is mounted, and
transmitting the obtained drive letter to a distribution apparatus, and dynamically generating a reference path for the group of encrypted digital content files.

27. The digital content playback apparatus according to claim 25, wherein the processes further comprise making a drive on which the virtual disk is mounted invisible when the virtual disk is mounted.

28. The digital content playback apparatus according to claim 27, the processes further comprise,
monitoring an invisibility setting state of the virtual disk and
unmounting the virtual disk when it is determined that the invisibility setting is cancelled.

29. A web content playback apparatus comprising:
a processor to execute a program; and
a memory to store the program which, when executed by the processor, performs processes of,
outputting an instruction signal to start a decryption process to a web content decrypting apparatus,
outputting an instruction signal to end the decryption process to the web content decrypting apparatus, and
integrating a group of unencrypted web content files distributed from a web content editing apparatus through a distribution apparatus and a group of encrypted web content files obtained from the web content editing apparatus through a recording medium, and allows a display apparatus to playback the integrated web content files, the encrypted web content files being decrypted by the web content decrypting apparatus using a part of the group of unencrypted web content files distributed from the web content editing apparatus through the distribution apparatus.

30. A web content decrypting apparatus comprising:
a processor to execute a program; and
a memory to store the program which, when executed by the processor, performs a process of decrypting a group of web content files that are obtained through a recording medium and encrypted by a web content editing apparatus by using a part of a group of unencrypted web content files distributed from a web content editing apparatus through a distribution apparatus.

31. A digital content encrypting/decrypting system comprising:
a digital content editing apparatus for, among generated digital content that is constituted by a group of files, uploading a group of files not to be encrypted to a distribution apparatus, and for encrypting a group of files to be encrypted and copying the group of encrypted files to a recording medium; and
a digital content playback apparatus for decrypting the group of files of the digital content encrypted by the digital content editing apparatus, and playing back the group of decrypted files by integrating the group of decrypted files with the group of unencrypted files of the digital content,
the digital content editing apparatus comprising:
a first processor to execute a program; and
a first memory to store the program which, when executed by the first processor, performs processes of,
processing data and generating digital content constituted by a group of files; and
encrypting the group of files to be encrypted among the group of files constituting the digital content by using a part of the group of files not to be encrypted among the group of files constituting the generated digital content, and
the digital content playback apparatus comprising:
a second processor to execute a program; and
a second memory to store the program which, when executed by the second processor, performs processes of,
decrypting the group of files of the digital content that are obtained through a recording medium and encrypted by the digital content editing apparatus, by using the part of the group of files of the digital content unencrypted and distributed from the digital content editing apparatus through the distribution apparatus; and
integrating the group of files of the digital content unencrypted and the group of files of the decrypted digital content, and allowing a display apparatus to playback the integrated files.

32. A digital content encrypting/decrypting method performed by both a digital content editing apparatus that, among generated digital content that is constituted by a group of files, uploads a group of files not to be encrypted to a distribution apparatus, and encrypts a group of files to be encrypted to copy the group of encrypted files to a recording medium, and a digital content playback apparatus that decrypts the group of files of the digital content encrypted by the digital content editing apparatus, and plays back the group of decrypted files by integrating the group of decrypted files with the group of unencrypted files of the digital content, wherein
in the digital content editing apparatus,
processing data to generate digital content constituted by a group of files, and
encrypting the group of files to be encrypted among the group of files constituting the digital content by using a part of the group of files not to be encrypted among the group of files constituting the generated digital content, and
in the digital content playback apparatus:
decrypting the group of files of the digital content that are obtained through a recording medium and encrypted by the digital content editing apparatus, by using the part of the group of files of the digital content unencrypted and distributed from the digital content editing apparatus through the distribution apparatus; and
integrating the group of files of the digital content unencrypted and the group of files of the digital content decrypted, and allowing a display apparatus to playback the integrated files.
